(19) United States
(12) Patent Application Publication
(10) Pub. No.: US 2011/0011867 A1
(43) Pub. Date: Jan. 20, 2011

(54) Dispensing Container and Closure

(75) Inventors: Scott Douglas SALMON, Tenafly, NJ (US); Mario Alexander Turchi, Tenafly, NJ (US)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser Inc., Parsippany, NJ (US)

(21) Appl. No.: 12/504,135

(22) Filed: Jul. 16, 2009

(51) Int. Cl. B65D 45/00; B65D 43/16; B67D 7/00

(52) U.S. Cl. 220/315; 220/810; 222/1

(57) ABSTRACT

A dispensing container comprising a container, and a one-piece closure removably affixed thereto. The one-piece closure includes at least one hinged portion, and at least one stationary portion which are hingedly interconnected, whereby the hinged portion may be temporarily locked into an open configuration at a desired angle relative to the stationary portion to permit for the dispensing of the contents of the container. Alternately the one-piece closure may be removed from the container to permit for the dispensing of the contents of the container, and thereafter the one-piece closure may be returned to reseal the container.

The present invention relates to a dispensing container and a closure for a container. The dispensing container is well suited for containing a mass of a material, or a plurality of particles or units, such as a powder, as well as items having a somewhat larger individual unit size. The present invention is particularly well adapted for use as a container for dispensing foodstuffs, such as snacks for direct consumption by an animal (human, pet, livestock) or for the storage and dispensing materials, e.g., condiments, spices, useful in the preparation of food for consumption.

Although the containment, and dispensing the of materials particularly foodstuffs is a technical problem which is been known throughout human history, and various containers and dispensing containers are known, there nonetheless remains a real need in the art for improvements to dispensing containers, closures for dispensing containers, and the like.

A shortcoming of may containers which include a resealable flap as part of a closure, such as are commonly encountered on larger containers use to contain and dispense powders, especially spices or other relatively small particulates therefrom are that upon opening of the resealable flap, during dispensing of the powder or particulate, the said flap is not immobilized and thus may interfere with the directed dispensing from the container. Additionally wherein such a flap is mobile, it may undesirably move and impart a flapping motion which can cause undesired dusting of the material, e.g., powder or particulates being dispensed. Further, frequently wherein a larger quantity of the material is desired to be dispensed, a user of the dispenser must typically seal the resealable flap of the closure, and then disengage the closure from the container typically such as by unscrewing the closure, or strongly pulling the closure from a generally tight snap-type connection with the container. Besides being inconvenient or difficult, particularly in persons with reduced manual dexterity, such also risks the undesired or accidental spillage of the material within the container.

The present invention addresses and overcomes the foregoing shortcomings, as well as further shortcomings in the art of closures and dispensing containers.

According to a preferred embodiment of the present invention, there is provided a one-piece closure for dispensing container. By “one-piece” is meant that the closure is unitary article which may be molded so to form a unitary article, or which may be assembled from discrete components to form the closure which following assembly, is a unitary article. The closure may be adapted to be permanently attached, but is most preferably removably attached to the container. The closure mounted on the container defines a dispensing container. The base of the closure defines a shape which is complementary to the shape of the container to which it attached and in particular defines a shape complimentary to the region surrounding an opening of the dispensing container. By “complimentary” is to be understood that the base of the closure is fittable upon the container. The shape of the region of the opening of the dispensing container can be any geometrical shape, round, elliptical, oval, and that the like. The closure is attachable to the dispensing container and when the closure is in a “closed” configuration, the closure spans the opening of the dispensing container, thereby retaining the contents of the dispensing container within its interior. The closure also may assume an “open” configuration wherein a hinged portion thereof hingedly pivots upward and away from the interior of the container, and thereby defines a partial opening from which the contents of the container can be dispensed. Advantageously, the closure includes locking means whereby the hinged portion of the closure can be retained at a respective or predetermined angle with respect to the opening of the container and/or with respect to the stationary portion of the closure retained upon the container. Such locking means provides for the retention of the hinged portion to be spaced away from the top of the container, and simultaneously defines an egress passage which permits for dispensing of the contents such as via lifting and tilting of the dispensing container. At the same time the hinged portion of the closure also provides for degree of flow direction thereby defining and, limiting the angle of the egress of the contents of the dispensing container. Furthermore, as the hinged portion of the closure is temporarily locked at a specific angle, such permits for a user to conveniently dispense the contents of the dispensing container using one hand as the user's second hand is not required to keep the hinged portion of the closure open during dispensing. Conveniently, as the hinged portion of the closure is temporarily locked into specific angle, such also eliminates undesirable movement or “flapping” of the hinged open part with respect to the container, a problem frequently observed on prior art containers for dispensing spices and the like. Elimination of such flapping via the use of the closure of the invention in a dispensing container provides for improved control in directing the dispensing of the contents of the container, and further minimizes dusting wherein the contents may be a powder, particulate or other solid material.

According to this preferred embodiment, advantageously the one-piece closure can also be readily removed from the container, thereby exposing the complete opening of the container from which the contents can be dispensed. After such dispensing, the one-piece closure of the invention can be conveniently reassembled and reattached to the container thereby once again sealing the dispensing container. According to this preferred embodiment, the shape of the region surrounding an opening of the dispensing container includes recesses which are configured to interact and cooperate with portions of the one-piece closure.

In a further embodiment of the invention, there is provided a one-piece closure as described above, wherein the locking means is adapted to permit for the temporary locking of the hinged portion of the closure at a least two, but preferably three (or even more) different respective or predetermined angles with respect to the opening of the container or with respect to the stationary portion of the closure retained upon the container.

According to a still further embodiment of the invention there is provided a one-piece closure as described above, which comprises a single hinged portion, and a single stationary portion.

According to a yet further embodiment of the invention, there is provided a one-piece closure as described above, which comprises a plurality of hinged portions, and at least one, but preferably only one, stationary portion.

These aspects and further features and embodiments of the invention are described with reference to the following drawings.

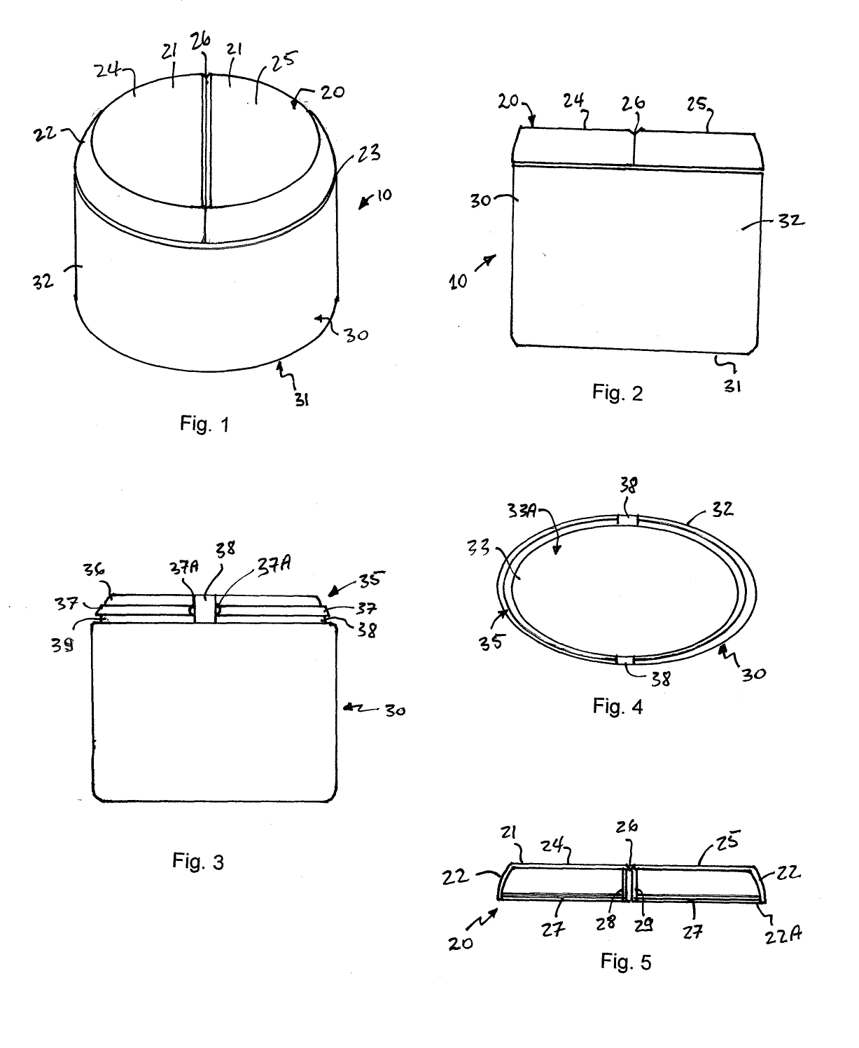

FIG. 1 provides a perspective view of a one-piece closure according to the invention mounted upon a container, thereby cumulatively forming a dispensing container.

FIG. 2 provides a side elevation view of the one-piece closure mounted upon the container of FIG. 1

FIG. 3 provides a side elevation view of the container of FIGS. 1 and 2, with the one-piece closure detached therefrom.

FIG. 4 provides a top plan view of the container of FIG. 3.

FIG. 5 provides a side elevation view of the one-piece closure of FIGS. 1 and 2, in a partial phantom view illustrating interior elements of the closure.

FIG. 5A provides a plan view of the interior of the one-piece closure of FIGS. 1, 2, and 5 which has a base mountable upon the container of FIG. 4.

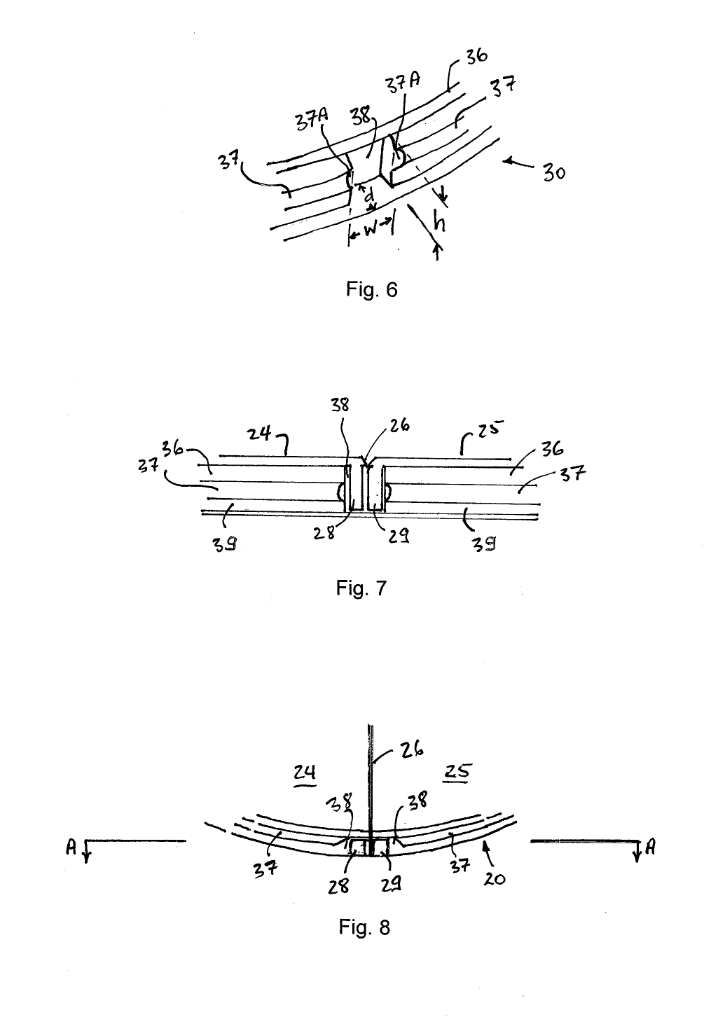

FIG. 6 provides a detail of a perspective view of a retention recess forming part of the container.

FIG. 7 illustrates a detail of a side elevation view of a part of a one-piece closure in a partial phantom view illustrating interior elements of the closure, and the relative placement of said interior elements in a retention recess forming part of the container, wherein the one-piece closure is in a “closed” configuration.

FIG. 8 illustrates a detail of a top plan view of a part of a one-piece closure in a partial phantom view illustrating interior elements of the closure, and the relative placement of said interior elements in a retention recess forming part of the container of FIG. 7.

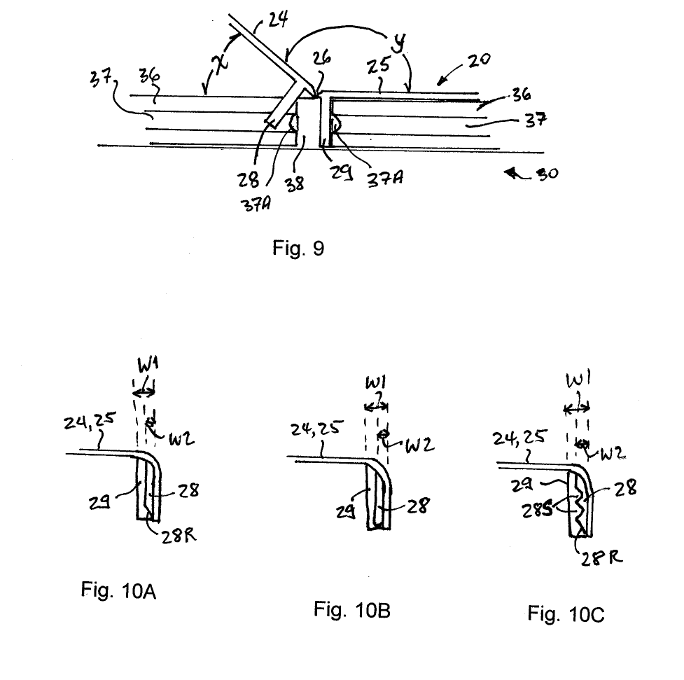

FIG. 9 depicts a detail of a side elevation view of a part of a one-piece closure in a partial phantom view taken along the vertical plane passing through part of the dispensing container at line A-A of FIG. 8, illustrating interior elements of the closure, and the relative placement of said interior elements in a retention recess forming part of the container, wherein the one-piece closure is in an “open” configuration.

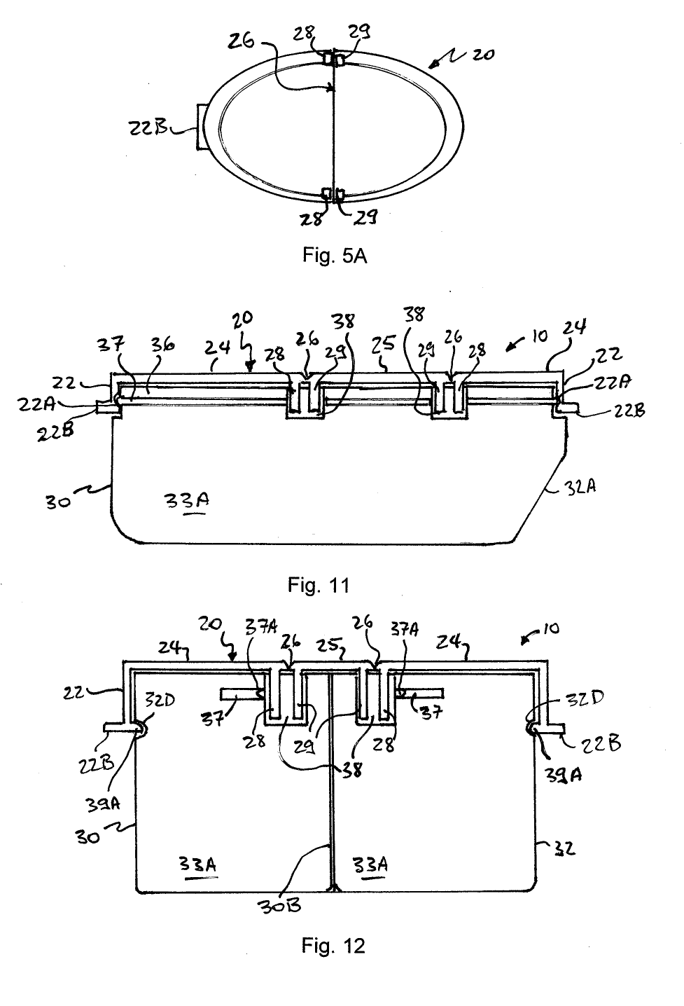

FIGS. 10A, 10B and 10C depict a detail of elevation views of several locking means forming part of the one-piece closure.

FIG. 11 depicts a side elevation and partial cross sectional, part phantom view of a further embodiment of the invention, wherein the one-piece closure includes two hinged portions, and a stationary portion therebetween, mounted on a container and thereby cumulatively forming a dispensing container.

FIG. 12 illustrates in a side elevation and partial cross sectional, part phantom view of a yet further embodiment of the invention, wherein the one-piece closure includes two hinged portions, having a stationary portion therebetween, mounted on a container having an internal barrier wall dividing the same into two separate internal compartments and thereby cumulatively forming a further example of a dispensing container according to the invention.

Various configurations of dispensing devices according to the present invention, including certain particularly preferred embodiments, are depicted on the following figures. In the accompanying figures, like elements are indicated using the same numerals throughout the figures.

FIG. 1 provides a perspective view of a one-piece closure 20 according to the invention mounted upon a container 30, thereby cumulatively forming a dispensing container 10. In the depicted embodiment, the container 30 includes a base 31 which may be generally planar, which base 31 extends radially outwardly to an upwardly extending, depending sidewall 32 which extends upward and away from the base 31 and terminates at an opening 33. The base 31, sidewall 32 and the opening 33 define an interior of the container 30. As is more clearly visible from FIG. 4, the container 30 according to the present embodiment is generally oval (or elliptical) in cross-section but the geometry of the container can be any other shape including circular, as well as noncircular geometries. Furthermore, while the cross-sectional area of the embodiment depicted is generally uniform at any point or plane parallel to the base 31, such is not essential to the invention and tapered, bulged, or other configurations of the container 30 and the sidewall 32 may also be used. As is more clearly visible in FIGS. 3 and 4, the opening 33 is defined by the region 35 of the dispensing container surrounding the opening 33. The region 35 in the embodiment depicted on the figures includes a trunk part 36 which includes at least one, but here two outwardly extending peripheral snap-ring parts 37, which trunk part 36 also includes pair of retention recesses 38 which are more clearly visible on FIG. 4 and which are diametrically spaced apart across from each other both on the trunk part 36 and on the region 35 surrounding the opening 33 of the dispensing container 10. The snap ring parts 37 define a snap recess 38 beneath the snap ring parts 37 and a portion of the sidewall 32. As is clearly seen on FIGS. 3 and 4, the snap ring parts 37 are interrupted by the pair of retention recesses 38. The ends 37A of the snap ring parts 37 are advantageously obliquely angled with respect to the retention recesses 38 so to provide a ramp-like configuration to ends 37A.

As illustrated on FIGS. 1 and 2, the one-piece closure 20 includes a top surface 21 which is essentially planar or flat (but need not be), a depending sidewall 22 having a base 23 defining a shape which is complementary to the shape of the region 35 surrounding the opening 33 of the dispensing container 10, such that the one-piece closure 20 can be mounted thereon, thereby sealing the opening 33 and the interior of the container 33A. With the opening 33 thus sealed, the contents of the container 30 cannot be removed but are retained within the container. The one-piece closure 20 includes two parts, a hinged portion 24 and a stationary portion 25 interconnected by an intermediate hinge 26. The intermediate hinge 26 permits for the movement of the hinged portion 24 with respect to this stationary portion 25 along the axis of the hinge 26. With regard now to FIG. 5 certain interior elements of the one-piece closure 20 are depicted. As is seen thereon, the one-piece closure 20 includes complementary snap elements 27 extending at least partially at or near the inner periphery 22A of the base 22. These complementary snap elements 27 are dimensioned such that they interact with, or are accommodated within, the snap recess 39, and/or are retained beneath the snap ring parts 37 of the container 30 when the one-piece closure 20 is mounted on the container 30. Further, the one-piece closure 20 includes at least one locking means 28 which is an element which extends inwardly from the sidewall 22 in near proximity to, or adjacent to one end of the hinge 26 of the hinged portion 24. Advantageously the locking means 28 is vertically disposed, that is to say is perpendicular to the top 21. The one-piece closure 20 further includes a least one retention means 29 which also extends inwardly from the sidewall 22 in near proximity, or adjacent to one end of the hinge of the stationary portion 25 of the one-piece closure 20, and it is also advantageously similarly vertically disposed. The locking means 28 and the retention means 29 are spaced apart from one another, but advantageously can be generally parallel to each other. In preferred embodiments, a two such locking means 28 and two such retention means 29 are present on the one-piece closure 20 such that each hinged portion 24 comprises two locking means 28, each stationary portion comprises two retention means 29, at least one of each a locking means 28 and a retention means 29 can be positioned within the retention recess 38 of the container 30 when the one-piece closure 20 is in a closed configuration. Advantageously, in such preferred embodiments as the trunk part 36 includes a pair of such retention recesses 38 which are diametrically spaced apart across from each other both on the trunk part 36 and on the region 35 surrounding the opening 33 of the dispensing container, similarly the one-piece closure 20 also includes two pairs of the locking means 28 and retention means 29 one of each such pairs can be cooperatively engaged within a retention recess 38 (as illustrated on FIGS. 7, 8 and 9) in a similar diametrically spaced apart configuration with respect to the one-piece closure 20 so that the said one-piece closure 20 and the trunk 36 of the container 30 can be removably affixed together. Such is depicted with reference to the container 30 on FIG. 4, and with reference to a one-piece closure on FIG. 5A.

Turning now to FIG. 6, in preferred configuration, the retention recess 38 is situated within a part of the trunk 36 as illustrated. In this detailed oblique view, the ends 37A of the snap ring parts 37 are advantageously obliquely angled with respect to the retention recesses 38 to provide a ramp-like configuration to these ends 37A which facilitates the respective movement of the locking means 28 over these ends 37A when the hinged portion 24 is displaced away from the container 30. The recess 38 itself has a depth dimension “d”, a height dimension “h” as well as a width dimension “w”, each of which are sufficiently large so to accommodate portions of the locking means 28 and the retention means 29 which extend into the recess 38. The respective positions of the foregoing elements and in particular the locking means 28, retention means 29 within the recess 38 when the one-piece closure 20 is in a closed configuration is visible in the elevation view provided by FIG. 7, as well as in the detail top view provided in FIG. 8.

The operating characteristics of the one-piece closure 20 and the container 30 are described in greater detail with reference to FIG. 8 which depicts the hinged portion 24 in an “open” configuration. As is seen thereon, the hinged portion 24 is spaced away from the container 30 such that access to the interior of the container 30 (not shown) and its contents are now possible. The hinged portion 24 it releasably retained or “locked” at a desired angle “x” with respect to the container 30, or to the stationary portion 25 by virtue of a mechanical connection, such as frictional forces between the interlocking portions of the locking means 28 with part of the trunk 36 and as here illustrated, frictional forces between the locking means 28 and a portion of the snap ring of 37. As a hinged portion 28 is opened, such as by a user grasping the dispensing container 10 and lifting the hinged portion 28 away from the container 30, the hinged portion 20 rotates about the hinge 26 sufficiently such that the locking means 28 transits out from the retention recess 38 where the locking means can come into mechanical, or frictional engagement with a portion of the trunk and especially the snap ring 37. Ideally, as the material of construction of the container 30 and/or the one-piece closure 20 is a least somewhat flexible, flexure of one or both of the locking means 28 and/or a portion of the trunk 36 or the snap ring 37 provides for opposing compressive forces such that when the dispensing container 10 is lifted and tilted so as to dispense its contents from the interior 33A of the container 30 via the now partially opened opening 33, the relative position of the hinged portion 20 is retained at or about the desired angle “x”. The desired angle “x” can be any angle, but his advantageously between 5°-90° (degrees of arc), preferably is between 20° and 70°, especially preferably is between about 25° and 60°. During dispensing, retention of the desired angle of the hinged portion 20 provides for improved control of the direction of dispensing of the contents of the dispensing container 10, which may also advantageously minimize unwanted wastage of the material being dispensed, and unwanted dusting is reduced as flapping of a part of the closure is eliminated. Advantageously, and certain embodiments, the locking means can include a configuration or elements wherein two or more desired angles “x” can be established.

A further advantage in feature of the preferred embodiment of the invention resides in the fact that while the hinged portion 20 is in a closed position (e.g., see FIG. 7) or is in an open position (e.g., see FIG. 9) the one-piece closure 20 also includes a retention means 29 which is engaged within the retention recess 38. The retention means 29 is suitably configured such that in conjunction with other elements, such as complementary snap elements 27 extending at least partially at or near the inner periphery 22A of the base 22, which are used to retain the one-piece closure 20 upon the container 30, such that the one-piece closure 20 can only be disengaged and removed from the container 30 when the hinged portion 20 is sufficiently rotated with respect to the container 30 such that it and its locking means 28 are fully disengaged from the trunk 36 of the container 30, and thereafter the stationary portion 25 can be lifted or otherwise withdrawn away from the container 30 and disengaged. However, the retention means 29 in conjunction with other elements, e.g., complementary snap elements 27 extending at least partially at or near the inner periphery 22A of the base 22, are used to retain the one-piece closure 20 upon the container 30 when the hinged portion 24 is mounted on the container 30, or when the hinged portion 24 is rotated away from the container and the locking means 28 are engaged with a part of the container 30, e.g., a part of the trunk 36. In this manner, the one-piece closure 20 provides for two convenient dispensing modes namely, (i) dispensing only via the open hinged portion 24, and (ii) dispensing from the opening 33 when the one-piece closure 20 is removed from the container 30. Such dual modes of dispensing may be both particularly practical and advantageous where a multiple modes of dispensing of the contents of the container 30 may be desired.

Conveniently, subsequent to dispensing from the dispensing container 10, the one-piece closure 20 can be reattached to the container 30, or the hinged portion 24 can be rotated with respect to the container 30 and the one-piece closure 20 returned to the closed position as depicted on FIGS. 1 and 2, as appropriate.

According to preferred embodiments, the one-piece closure 20 is retained on the container 30 by virtue of complementary snap elements 27 which are dimensioned such that they interact with, or are accommodated within, the snap recess 38, and/or are retained beneath the snap ring parts 37 of the container 30 when the one-piece closure 20 is mounted on the container 30, and not by any contact between the locking means 28 and the container 30.

According to the invention, the one-piece closure must include at least one of a hinged portion and at least one locking means, however particularly preferred are one-piece closures having at least two locking means present on the hinged portion, and a container having at least one but preferably two retention recesses, as generally described in the figures. In particularly preferred embodiments, the one-piece closure includes both a hinged portion having at least one locking means, but preferably at least two locking means, and a stationary portion having a least one retention means, but preferably at least two retention means, which is advantageously mounted or mountable upon a suitably dimensioned container having at least one retention recess, but preferably at least two retention recesses as generally described in the figures. It is further contemplated that a stationary portion may also function as a further, separate hinged portion if a first hinged portion (or a further stationary portion is present) is retained mounted on the container, in which case forgoing remarks concerning the stationary portion applies ‘mutatis mutandis’ to the hinged portion.

Several alternative embodiments of both locking means 28 and retention means 29 are shown in the details of the elevation views of FIGS. 10A, 10B and 10C. It is to be understood however that such depict certain preferred embodiments, but such are presented by way of illustration only, and not by way of limitation.

In FIG. 10A. there is illustrated a portion of the hinged portion 24 which is to be understood as eclipsing a portion of the stationary portion 25 of the one-piece closure 20. Depending from the hinged portion 24, and inwardly of the sidewall 22 of the one-piece closure 20 is illustrated a locking means 28. The locking means 28 extends vertically, and includes a sloped base 28R. This sloped base 28R facilitates the sliding transit of the locking means 28 over parts of the trunk 36 and particularly the snap rings 37. As depicted, the locking means 28 also has a width “W2” extending inwardly from the depending sidewall 22. Also visible is an embodiment of the retention means 29 which is partially obscured by the locking means 28. The retention means 29 depends from the stationary portion 25 and inwardly on the sidewall 22 of the one-piece closure 20. As illustrated, the retention means 29 also has a width “W1” extending inwardly from the depending sidewall 22. While the widths of “W1” and “W2” may be coincident, or for that matter “W2” may be greater than “W1”, advantageously, width “W1” is greater than width “W2” so to improve the retention of the stationary portion 25 on the container 30 when the hinged portion 24 is opened and closed or otherwise moved. Further, both “W1” and “W2” are not greater than, but are preferably slightly lesser than the depth “d” of the retention recess 38. Furthermore, the overall dimensions of the locking means 28 and retention means 29 are such that they can be at least partially fitted within the height “h”, depth “d” and width “w” of the retention recess 38.

The embodiment of the locking means 28 and the retention means 29 as depicted on FIG. 10B are substantially similar to those depicted on FIG. 10B, except that locking means 28 no longer includes a sloped base. Such illustrates and that a sloped base may be omitted without detracting from the operation of the invention.

The embodiment of FIG. 10C is substantially similar to that described with reference to FIG. 10A but differs in the fact that the locking means 28 is profiled to include a plurality of locking recesses 28S, similar to the form of a sawtooth, or rising and falling waves which extends through the locking means 28. Preferably, the locking means 28 also includes a sloped base 28R as described with reference to FIG. 10A. the presence of one or more locking recesses 28S provides for the establishment of discrete positions within the locking means 28 whereby one or more preferred angles “x” as discussed with reference to FIG. 9 may be established. The use of profiled locking means as illustrated in FIG. 10C conveniently provides for locking means which can provide that the hinged portion 24 may be locked at two or more preferred angles “x”.

FIG. 11 illustrates an alternative embodiment of the dispensing container 10 according to the invention, which is similar in all respects to the embodiments discussed with reference to prior FIGS. 1-10, but differs in that the one-piece closure 20 includes a plurality of hinged portions 24 and 24A, which are hingedly affixed to an intermediate stationary portion 25, the container includes a sloped sidewall section 32A, and extending outwardly from the one-piece closure and integral thereto are a pair of outwardly extending tangs 22B which facilitate gripping and opening of a hinged portion 24, 24A. In this partial phantom, partial cross-sectional view of FIG. 11 both hinged portions 24 and 24A are shown in a “closed” configuration. An advantage of such a configuration of the invention permits for providing differently sized hinged portions 24, 24A as depicted in FIG. 11, which in turn provides for differently sized openings through which the contents of the container 30 may be dispensed. Further it is to be understood that the one-piece closure 20 is detachable and removable from the container 30 in the manner previously described.

FIG. 12 illustrates a still further alternative embodiment of a dispensing container 10 according to the invention which is again similar in all respects to the embodiments discussed with reference to FIGS. 1-10, but differs in that the one-piece closure 20 includes a plurality of hinged portions 24 and 24A are hingedly affixed to an intermediate stationary portion, wherein the one-piece closure 20 is affixed to a container 30 which has two or more separate internal compartments 33A therein, such as can be conveniently provided by a container having an internal barrier wall 30A dividing the interior of the container 30. Additionally this embodiment also depicts extending outwardly from the one-piece closure and integral thereto a pair of outwardly extending tangs 22B which facilitate gripping and opening of a hinged portion 24, 24A. In the partial phantom, partial cross-sectional view of FIG. 12 both hinged portions 24 and 24A are shown in a “closed” configuration, and an internal barrier wall 30B dividing the container 30 is illustrated. FIG. 12 also illustrates an embodiment wherein only a small segmented snap ring part 37 is sufficient and the snap ring part 37 need not extend about a large part of the periphery of the trunk 36 of the container 10, as generally depicted in prior figures. In such an embodiment, an alternate temporary locking means may be used in place of the complementary snap elements 27 dimensioned such that they interact with, or are accommodated within, the snap recess 39, and/or are retained beneath the snap ring parts 37 of the container 30 when the one-piece closure 20 is mounted on the container 30. Such alternate temporary locking means may include, for example an inwardly extending portion 39A of the one-piece closure 20 which removably engages with a dimpled recess 32D present within the sidewall 32 of the container 30.

In fact it is to be understood that the snap ring part 37 may be omitted from any of the embodiments of the invention as it is only required that when the lock means 28 transits out from the retention recess 38 it is only required that a at least a part of the lock means 28 physically engage a part of the container 10, which may be any part or portion thereof, so to temporarily retain or temporarily lock the hinged portion 24 at a desired angle “x” with respect to the container, which can also be defined as an angle “y” with respect to the stationary portion 25. The embodiment according to FIG. 12 may be used to selectively dispense the materials contained in the separate internal compartments, or when the one-piece closure 20 is withdrawn from the container 30, the contents of the two or more internal compartments can be dispensed directly, preferably simultaneously dispensed. While not specifically shown in the drawing, the depicted container 30 may be substituted by two (or more) separate containers which may be joined to a one-piece closure 20 as well, for separately containing materials in their respective internal compartments.

While it is highly preferred that the one-piece closure 20 be removably affixed to the container 30, it is foreseen that such is not an essential requirement in all aspects of the invention and it may be desired that the one-piece closure 20 be permanently affixed to the container 30. In such an embodiment, the retention means 29 may be omitted, and the retention portion 25 may be permanently affixed to a part of the container 30 by any conventional means (mechanical or chemical bonding, heat welding, adhesive, snap-fit, etc.), in which case only the hinged portion 24 and the locking means 28 are necessary. In such embodiments the dimensions of the retention recesses 38 may also be reduced as needing to only accommodate the locking means 38.

The materials of contraction of the dispensing container 10 according to the invention, and especially the one-part closure 20 may be any suitable material which can provide the required mechanical function described above and which is compatible with the contents of the container 30. Exemplary suitable material including metals, formed (stamped, cast) metals, foils, paper, fibrous substrates, multi-laminar sheets such as those containing paper, foils, and/or polymer films may be used. Advantageously synthetic polymers come into consideration. Any of a number of thermosettable or thermoformable synthetic polymers such as are widely used in casting or injection molding. Exemplary synthetic polymers such as polyamides, polyolefins (e.g., polypropylene, polyethylene) as well as polyalkyleneterephalates (i.e., polyethylene terephthalate, polybutylene terephthalate), polystyrenes, polysulfones, polycarbonates as well as copolymers formed from monomers of one or more of the foregoing being several nonlimiting examples of useful synthetic polymers. Preferably the material of construction is at least somewhat flexible.

The hinge of the one-piece closure 20 can be provided by discrete names such as a separate or discrete metal or synthetic polymer hinge but advantageously is a “living hinge” which is formed simultaneously with the molding a synthetic polymer into the one-piece closure 20 of the invention. The advantage of a living hinge is in its low cost, and reduced assembly costs.

Dispensing containers according to the invention can be used to dispense any of a wide variety of materials. Thus methods of containing materials within the dispensing containers and dispensing said materials therefrom are also features of the present invention. Coming into consideration are flowable materials, such as liquids, powders, prills, pills, bead like articles, as well as discrete formed articles of commerce, e.g., tablets, coated tablets, gelpacs. Such may be, e.g., products use in a cleaning operation such as hard surface cleaning, laundry or dishwashing operation including automatic dishwashing operations, as well as for pharmaceutical compositions or other medicaments. The dispensing container according to the invention is very well suited for containing, and dispensing foodstuffs, such as snacks for direct ingestion by an animal (human, pet, livestock) or for the storage and dispensing of flowable materials, e.g., condiments, spices, useful in the preparation of food for consumption. Dispensing of a material from within the dispensing containers requires either forming an opening by displacing the hinged portion by displacing it upwardly from the container to a desired angle “x” and thereafter removing some or all of the contents within the interior of the container, and/or by removing and separating the one-piece closure from the container and thereafter removing some or all of the contents within the interior of the container. Removal may be by withdrawing such as via an instrument or utensil, e.g., measuring spoon, tube or straw, but more conveniently the container may be lifted and tilted so allow the material contained within its interior to flow, spill or roll out of the container.

The foregoing figures have illustrated certain preferred embodiments of the invention. It is to be understood that the figures are provided by way of illustration only and that further useful embodiments and configurations of the one-piece closure or dispensing container falling within the scope of the present invention and the claims may be readily produced by one skilled in the art without deviating from the scope and spirit of the invention.

1. A dispensing container comprising:
a container having an opening, and interior and at least one retention recess, and, a one-piece closure mounted on the container covering the opening, having a hinged portion hingedly connected to a stationary portion, said hinged portion having at least one locking means, wherein the hinged portion is moveable with respect to the container between a first configuration wherein the said locking means is retained within the retention recess, and a second configuration wherein the said locking means is at least partially displaced from the retention recess and in mechanical contact with a further portion of the container which releasably locks the hinged portion at an angle x, and provides for access to the interior of the container.

2. A dispensing container according to claim 1, wherein:
the stationary portion comprises at least one retention means.

3. A dispensing container according to claim 1, wherein:
the one-piece closure comprises a hinged portion includes at least two locking means, the stationary portion includes at least two retention means, and, the container includes a least two retention recesses.

4. A dispenser container according to claim 1, wherein:
the one-piece closure is permanently affixed to the container via the retention portion.

5. A dispensing container according to claim 1, wherein:
the one-piece closure comprises at least two hinged portions.

6. A dispensing container according to claim 5 wherein:
each of the two hinged portions comprises at least two locking means.

7. A one-part closure for a dispensing container comprising:
a hinged portion hingedly connected to a stationary portion, said hinged portion having at least one locking means, wherein the hinged portion is adapted to be moveable with respect to the container between a first configuration wherein the said locking means is retained within a retention recess of the container, and a second configuration wherein the said locking means is at least partially displaced from the retention recess and in mechanical contact with a further portion of the container which releasably locks the hinged portion at an angle x, and provides for access to the interior of the container.

8. A one-piece closure according to claim 7, wherein:
the stationary portion comprises at least one retention means.

9. A one-piece closure according to claim 7, wherein:
the one-piece closure comprises a hinged portion includes at least two locking means, the stationary portion includes at least two retention means.

10. A method of containing and dispensing material from a dispensing container, comprising the steps of:
providing a dispensing container according to claim 1 containing a quantity of a material within the interior of the container,
opening the hinged portion of the one-piece closure to releasably lock the hinged portion at an angle x, or alternately, removing the one-piece closure and separating it from the container,
subsequently removing material from the interior of the container thorough the opening.
